(19) United States
(12) Patent Application Publication
(10) Pub. No.: US 2024/0058927 A1
(43) Pub. Date: Feb. 22, 2024

(54) IMPACT TOOL

(71) Applicant: MAKITA CORPORATION, Anjo-shi (JP)

(72) Inventors: Koji YAMANAKA, Anjo-shi (JP); Koji TSUKAMOTO, Anjo-shi (JP); Tomoro AOYAMA, Anjo-shi (JP)

(73) Assignee: MAKITA CORPORATION, Anjo-shi (JP)

(21) Appl. No.: 18/220,030

(22) Filed: Jul. 10, 2023

(30) Foreign Application Priority Data
Aug. 22, 2022 (JP) 2022-131954

(51) Int. Cl. B25B 21/02

(52) U.S. Cl. CPC B25B 21/026

(57) ABSTRACT

The inclination of a hammer with respect to a spindle is reduced. An impact tool includes a motor, a spindle at least partially located frontward from the motor and rotatable by the motor, a hammer surrounding the spindle, an anvil at least partially located frontward from the spindle and strikable by the hammer in a rotation direction, and three or more balls between the spindle and the hammer.

### CROSS-REFERENCE TO RELATED APPLICATIONS

This application claims the benefit of priority to Japanese Patent Application No. 2022-131954, filed on Aug. 22, 2022, the entire contents of which are hereby incorporated by reference.

### BACKGROUND

### 1. Technical Field

The present disclosure relates to an impact tool.

### 2. Description of the Background

In the technical field of impact tools, a known impact tool is described in Japanese Unexamined Patent Application Publication No. 2021-037560. The impact tool includes a spindle, a hammer surrounding the spindle, and balls located between the spindle and the hammer.

### BRIEF SUMMARY

For example, in a screwing operation with an impact tool, an anvil may receive a predetermined or higher load. The anvil and the hammer then stop rotating. When the hammer stops rotating and the spindle rotates, the hammer and the spindle slide on each other.

When the hammer is inclined with respect to the spindle in this state, a frictional force increases locally between the hammer and the spindle. This may cause excess wear or seizure of at least the hammer or the spindle and may shorten the service life of the impact tool.

One or more aspects of the present disclosure are directed to reducing the inclination of a hammer with respect to a spindle.

A first aspect of the present disclosure provides an impact tool, including:
a motor;
a spindle at least partially located frontward from the motor and rotatable by the motor;
a hammer surrounding the spindle;
an anvil at least partially located frontward from the spindle and strikable by the hammer in a rotation direction; and
three or more balls between the spindle and the hammer.

The technique according to the above aspect of the present disclosure reduces the inclination of the hammer with respect to the spindle.

### BRIEF DESCRIPTION OF DRAWINGS

FIG. 1 is a perspective view of an impact tool according to an embodiment as viewed from the front.

FIG. 2 is a side view of an upper portion of the impact tool according to the embodiment.

FIG. 3 is a longitudinal sectional view of the upper portion of the impact tool according to the embodiment.

FIG. 4 is a horizontal sectional view of the upper portion of the impact tool according to the embodiment.

FIG. 5 is a cross-sectional view of the upper portion of the impact tool according to the embodiment.

FIG. 6 is a partially exploded perspective view of a main part of the impact tool according to the embodiment.

FIG. 7 is a front view of a spindle and a hammer in the embodiment.

FIG. 8 is a top view of the spindle in the embodiment.

FIG. 9 is a bottom view of the spindle in the embodiment.

### DETAILED DESCRIPTION

One or more embodiments will now be described with reference to the drawings. In the embodiments, the positional relationships between the components will be described using the directional terms such as right and left (or lateral), front and rear (or frontward and rearward), and up and down (or vertical). The terms indicate relative positions or directions with respect to the center of an impact tool 1. The impact tool 1 includes a motor 6 as a power source.

In the embodiments, a direction parallel to a rotation axis AX of the motor 6 is referred to as an axial direction for convenience. A direction about the rotation axis AX is referred to as a circumferential direction or circumferentially, or a rotation direction for convenience. A direction radial from the rotation axis AX is referred to as a radial direction or radially for convenience.

The rotation axis AX extends in the front-rear direction. A first axial direction is from the rear to the front. A second axial direction is from the front to the rear. A position nearer the rotation axis AX in the radial direction, or a radial direction toward the rotation axis AX, is referred to as radially inward for convenience. A position farther from the rotation axis AX in the radial direction, or a radial direction away from the rotation axis AX, is referred to as radially outward for convenience.

### Impact Tool

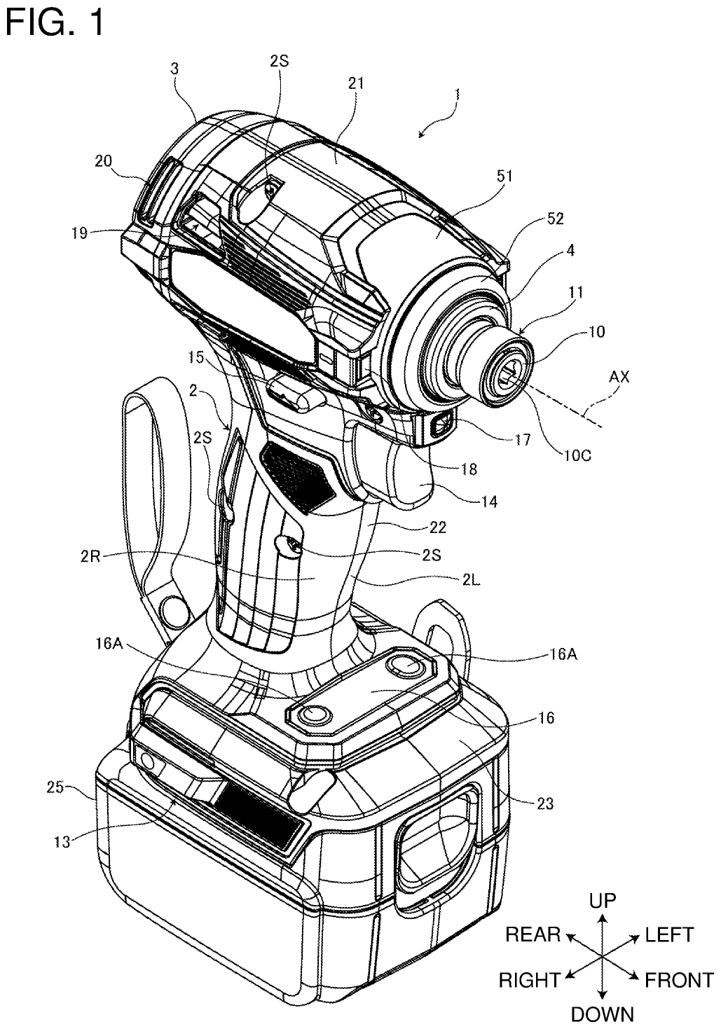

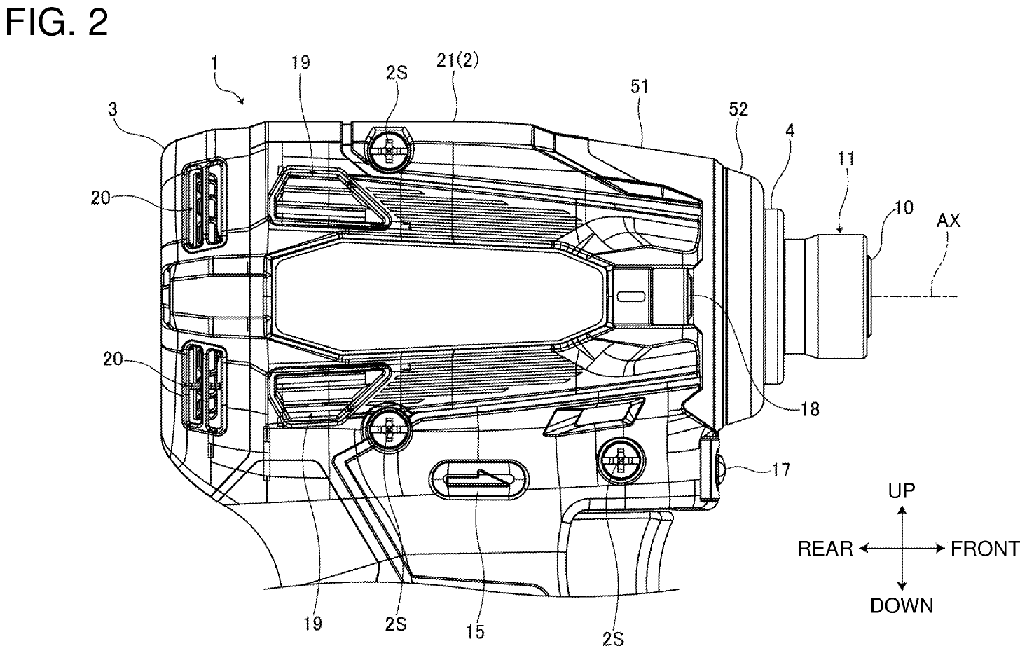

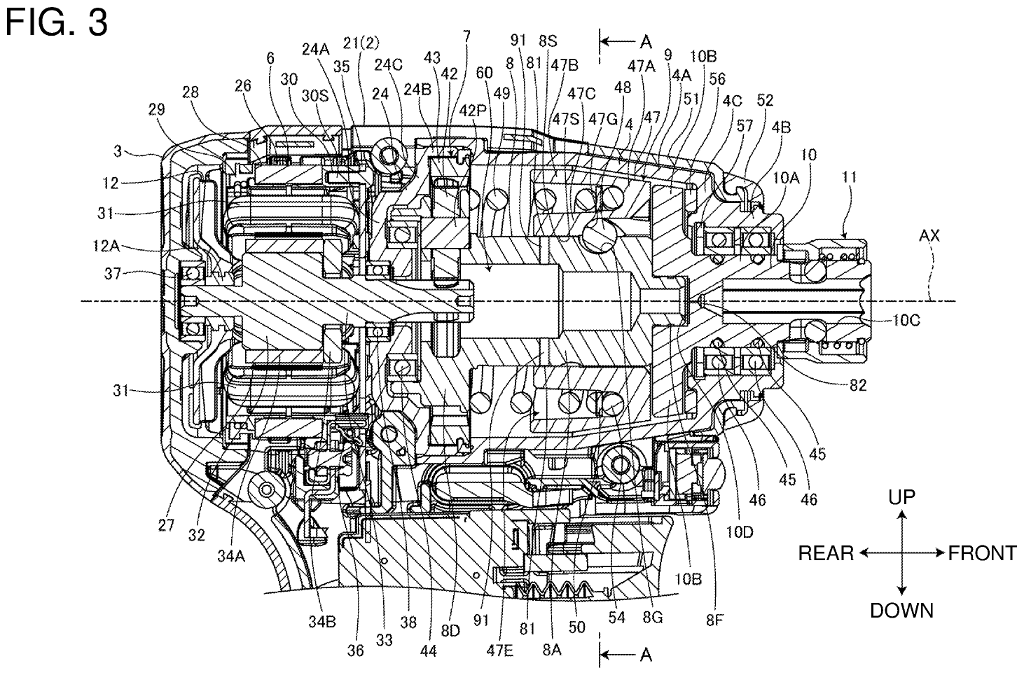

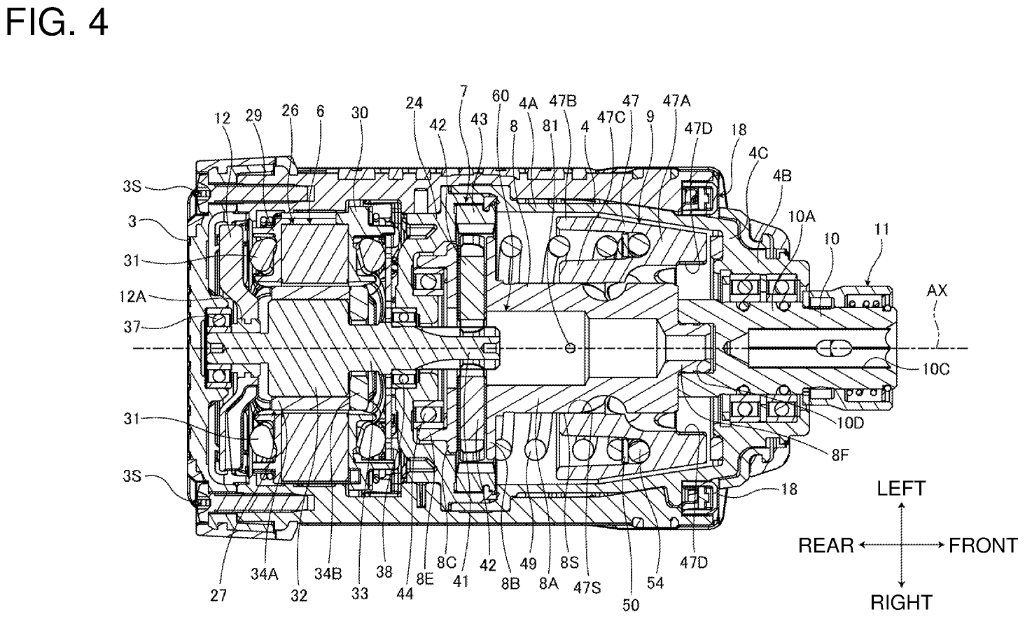

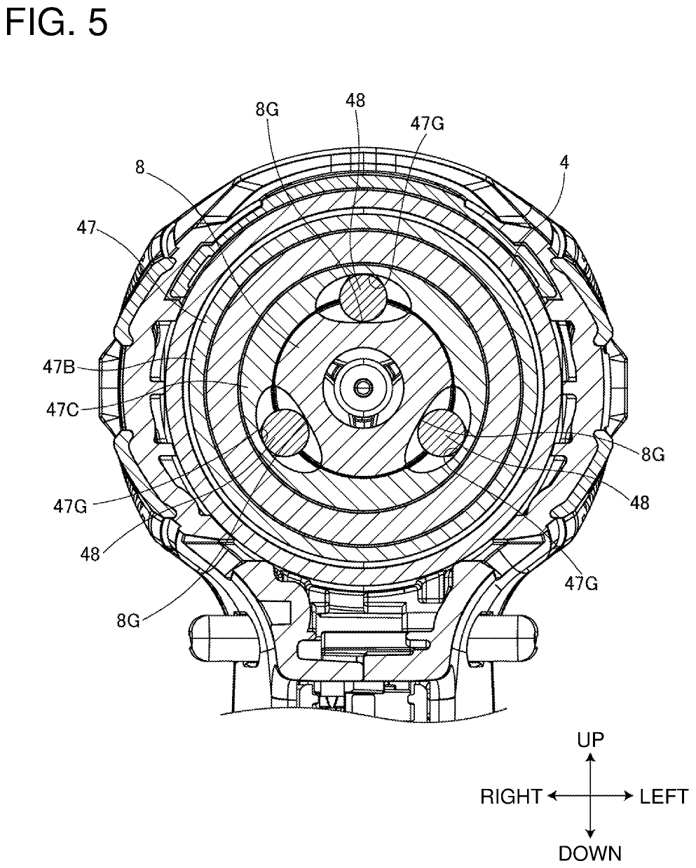

FIG. 1 is a perspective view of the impact tool 1 according to an embodiment as viewed from the front. FIG. 2 is a side view of an upper portion of the impact tool 1. FIG. 3 is a longitudinal sectional view of the upper portion of the impact tool 1. FIG. 4 is a horizontal sectional view of the upper portion of the impact tool 1. FIG. 5 is a cross-sectional view of the upper portion of the impact tool 1, taken along line A-A as viewed in the direction indicated by the arrows in FIG. 3.

The impact tool 1 according to the embodiment is an impact driver that is a screwing tool. The impact tool 1 includes a housing 2, a rear cover 3, a hammer case 4, a bearing box 24, a hammer case cover 51, a bumper 52, a motor 6, a reducer 7, a spindle 8, a striker 9, an anvil 10, a tool holder 11, a fan 12, a battery mount 13, a trigger lever 14, a forward-reverse switch lever 15, an interface panel 16, a hand mode switch button 17, and light assemblies 18.

The housing 2 is formed from a synthetic resin. The housing 2 in the embodiment is formed from nylon. The housing 2 includes a left housing 2L and a right housing 2R. The right housing 2R is located on the right of the left housing 2L. The left housing 2L and the right housing 2R are fastened together with multiple screws 2S. The housing 2 includes a pair of housing halves.

The housing 2 includes a motor compartment 21, a grip 22, and a battery holder 23.
The motor compartment 21 accommodates the motor 6. The motor compartment 21 accommodates at least a part of the hammer case 4. The motor compartment 21 is cylindrical.

The grip 22 is grippable by an operator. The grip 22 extends downward from the motor compartment 21. The trigger lever 14 is located in an upper portion of the grip 22.

The battery holder 23 holds a battery pack 25 with the battery mount 13. The battery holder 23 is connected to the lower end of the grip 22. The battery holder 23 has larger outer dimensions than the grip 22 in the front-rear direction and in the lateral direction.

The rear cover 3 covers an opening in the rear end of the motor compartment 21. The rear cover 3 is located at the rear of the motor compartment 21. The rear cover 3 accommodates at least a part of the fan 12. The fan 12 is located inward from the rear cover 3. The rear cover 3 holds the rear rotor bearing 37. The rear cover 3 is formed from a synthetic resin. The rear cover 3 is fastened to the rear end of the motor compartment 21 with two screws 3S.

The motor compartment 21 has inlets 19. The rear cover 3 has outlets 20. Air outside the housing 2 flows into an internal space of the housing 2 through the inlets 19, and then flows out of the housing 2 through the outlets 20.

The hammer case 4 accommodates at least a part of the reducer 7, the spindle 8, the striker 9, and at least a part of the anvil 10. The hammer case 4 is formed from a metal. The hammer case 4 in the embodiment is formed from aluminum. The hammer case 4 is cylindrical. The hammer case 4 includes a larger cylinder 4A, a smaller cylinder 4B, and a joint 4C. The smaller cylinder 4B is located frontward from the larger cylinder 4A. The front end of the larger cylinder 4A and the rear end of the smaller cylinder 4B are connected to each other with the joint 4C. The joint 4C is annular. The larger cylinder 4A has a larger outer diameter than the smaller cylinder 4B. The larger cylinder 4A has a larger inner diameter than the smaller cylinder 4B.

The bearing box 24 accommodates at least a part of the reducer 7. The bearing box 24 holds a front rotor bearing 38 and a spindle bearing 44. The bearing box 24 is formed from a metal. The bearing box 24 is fastened to a rear portion of the hammer case 4. The bearing box 24 includes a rear annular portion 24A and a front annular portion 24B. The front annular portion 24B is located frontward from the rear annular portion 24A. The front end of the rear annular portion 24A and the rear end of the front annular portion 24B are connected to each other with a joint 24C. The joint 24C is annular. The rear annular portion 24A has a smaller outer diameter than the front annular portion 24B. The rear annular portion 24A has a smaller inner diameter than the front annular portion 24B. The bearing box 24 and the hammer case 4 may be fastened together by screwing or by fitting (engagement). For example, the front annular portion 24B may have threads on its outer circumference, and the larger cylinder 4A may have threaded grooves on its inner circumference. The threads on the front annular portion 24B may be engaged with the threaded grooves on the larger cylinder 4A to fasten the bearing box 24 and the hammer case 4 together. The front annular portion 24B may be fitted in the larger cylinder 4A to fasten the bearing box 24 and the hammer case 4 together. The front rotor bearing 38 is located radially inward from the rear annular portion 24A. The spindle bearing 44 is located radially inward from the joint 24C.

The hammer case 4 is held between the left housing 2L and the right housing 2R. The hammer case 4 includes the rear portion accommodated in the motor compartment 21. The hammer case 4 is connected to the front of the motor compartment 21. The bearing box 24 is fixed to the motor compartment 21 and the hammer case 4.

The hammer case cover 51 protects the hammer case 4. The hammer case cover 51 prevents contact between the hammer case 4 and objects nearby. The hammer case cover 51 covers the outer circumferential surface of the larger cylinder 4A.

The bumper 52 protects the hammer case 4. The bumper 52 prevents contact between the hammer case 4 and objects nearby. The bumper 52 reduces the impact of contact with an object. The bumper 52 surrounds the smaller cylinder 4B.

The motor 6 is a power source for the impact tool 1. The motor 6 is an inner-rotor brushless motor. The motor 6 includes a stator 26 and a rotor 27. The stator 26 is supported on the motor compartment 21. The rotor 27 is at least partially located inward from the stator 26. The rotor 27 rotates relative to the stator 26. The rotor 27 rotates about the rotation axis AX extending in the front-rear direction.

The stator 26 includes a stator core 28, a rear insulator 29, a front insulator 30, and multiple coils 31.

The stator core 28 includes multiple steel plates stacked on one another. The steel plates are metal plates formed from iron as a main component. The stator core 28 is cylindrical. The stator core 28 is located radially outward from the rotor 27. The stator core 28 includes multiple teeth to support the coils 31.

The rear insulator 29 and the front insulator 30 are electrical insulating members formed from a synthetic resin. The rear insulator 29 and the front insulator 30 each electrically insulate the stator core 28 and the coils 31. The rear insulator 29 is fixed to the rear of the stator core 28. The front insulator 30 is fixed to the front of the stator core 28. The rear insulator 29 partially covers the surfaces of the teeth. The front insulator 30 partially covers the surfaces of the teeth.

The coils 31 are wound around the stator core 28 with the rear insulator 29 and the front insulator 30 in between. The coils 31 surround the teeth on the stator core 28 with the rear insulator 29 and the front insulator 30 in between. The coils 31 and the stator core 28 are electrically insulated from each other with the front insulator 30 and the rear insulator 29 in between. The coils 31 are connected to one another with fusing terminals 36.

The rotor 27 rotates about the rotation axis AX. The rotor 27 includes a rotor core 32, a rotor shaft 33, a rotor magnet 34A, and a sensor magnet 34B.

The rotor core 32 and the rotor shaft 33 are formed from steel. In the embodiment, the rotor core 32 is integral with the rotor shaft 33. The rotor shaft 33 includes a rear portion protruding rearward from the rear end face of the rotor core 32. The rotor shaft 33 includes a front portion protruding frontward from the front end face of the rotor core 32.

The rotor magnet 34A is fixed to the rotor core 32. The rotor magnet 34A in the embodiment surrounds the rotor core 32. The sensor magnet 34B is fixed to the rotor core 32. The sensor magnet 34B in the embodiment is located on the front end face of the rotor core 32.

A sensor board 35 is attached to the front insulator 30. The sensor board 35 is fastened to the front insulator 30 with a screw 30S. The sensor board 35 includes an annular circuit board and a rotation detector. The rotation detector is supported on the circuit board. The sensor board 35 at least partially faces the front end face of the sensor magnet 34B. The rotation detector detects the position of the sensor magnet 34B to detect the position of the rotor 27 in the rotation direction.

The rotor shaft 33 has the rear end rotatably supported by a rear rotor bearing 37. The rotor shaft 33 has the front end rotatably supported by the front rotor bearing 38. The rear rotor bearing 37 is held by the rear cover 3. The front rotor bearing 38 is held by the bearing box 24.

The front end of the rotor shaft 33 is located in the internal space of the hammer case 4 through an opening of the rear annular portion 24A of the bearing box 24.

A pinion gear 41 is fixed to the front end of the rotor shaft 33. The pinion gear 41 is connected to at least a part of the reducer 7. The rotor shaft 33 is connected to the reducer 7 with the pinion gear 41.

The reducer 7 connects the rotor shaft 33 and the spindle 8 together. The rotor 27 drives the gears in the reducer 7. The reducer 7 transmits rotation of the rotor 27 to the spindle 8. The reducer 7 rotates the spindle 8 at a lower rotational speed than the rotor shaft 33. The reducer 7 is located frontward from the stator 26. The reducer 7 includes a planetary gear assembly.

The reducer 7 includes multiple planetary gears 42 and an internal gear 43. The multiple planetary gears 42 surround the pinion gear 41. The internal gear 43 surrounds the multiple planetary gears 42. The pinion gear 41, the planetary gears 42, and the internal gear 43 are accommodated in the hammer case 4. Each planetary gear 42 meshes with the pinion gear 41. The planetary gears 42 are rotatably supported by the spindle 8 with a pin 42P. The spindle 8 is rotated by the planetary gears 42. The internal gear 43 includes internal teeth that mesh with the planetary gears 42.

The internal gear 43 is fixed to the larger cylinder 4A in the hammer case 4. The internal gear 43 is constantly nonrotatable relative to the hammer case 4.

When the rotor shaft 33 rotates as driven by the motor 6, the pinion gear 41 rotates, and the planetary gears 42 revolve about the pinion gear 41. The planetary gears 42 revolve while meshing with the internal teeth on the internal gear 43. The revolving planetary gears 42 rotate the spindle 8, which is connected to the planetary gears 42 with the pin 42P, at a lower rotational speed than the rotor shaft 33.

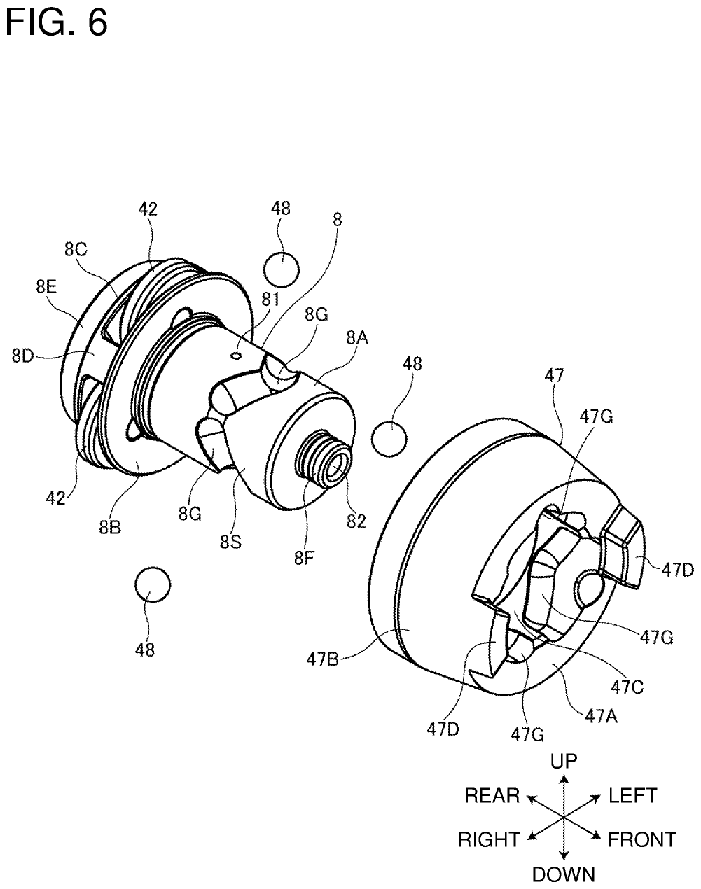

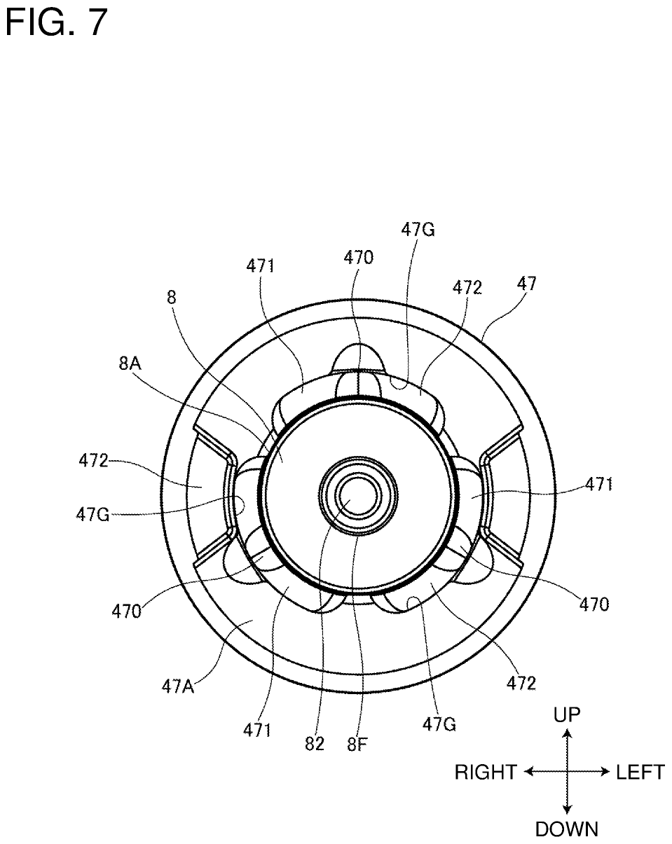

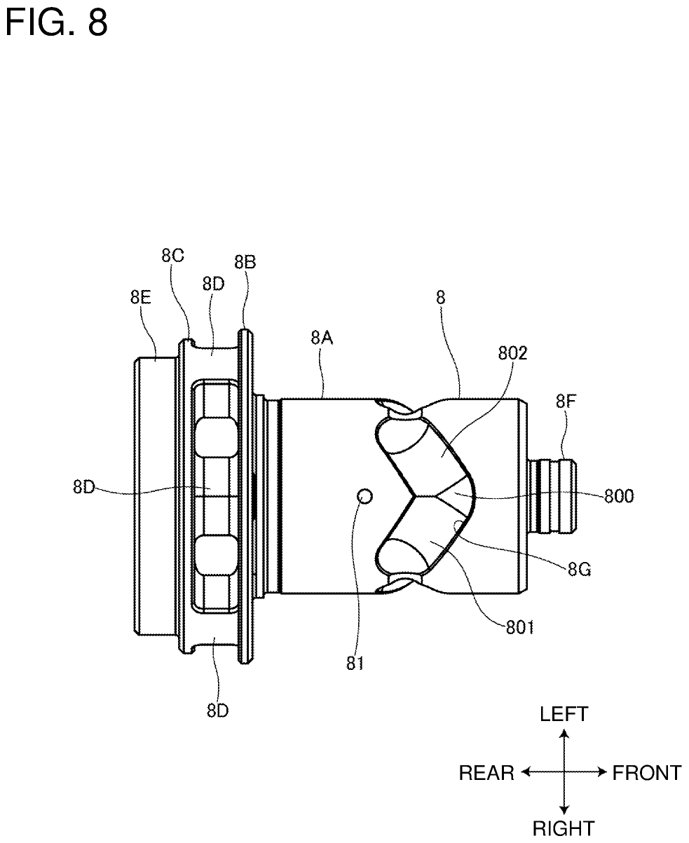

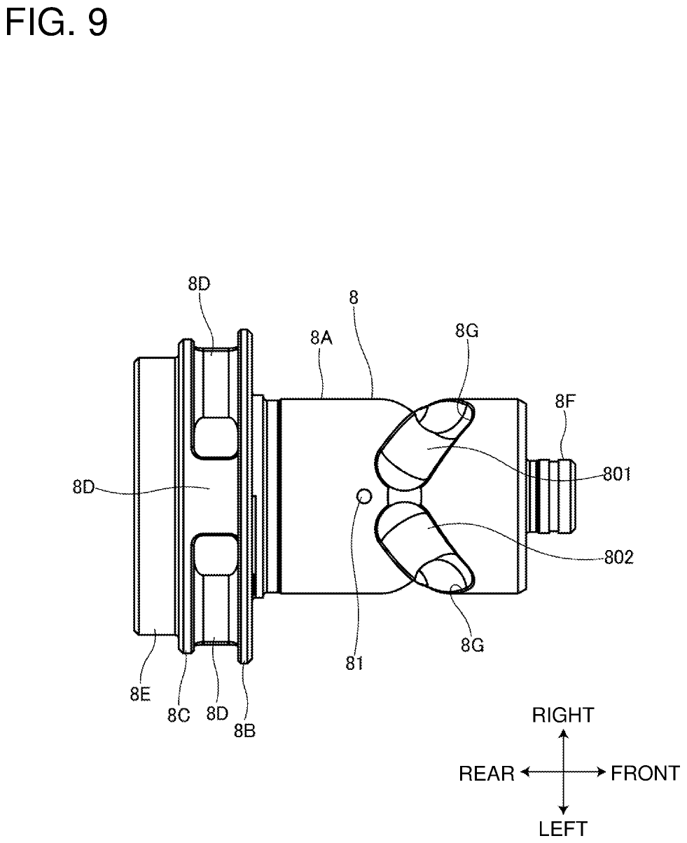

FIG. 6 is a partially exploded perspective view of a main part of the impact tool 1 according to the embodiment. FIG. 7 is a front view of the spindle 8 and the hammer 47. FIG. 8 is a top view of the spindle 8. FIG. 9 is a bottom view of the spindle 8.

The spindle 8 is rotated about the rotation axis AX by the motor 6. The spindle 8 is rotated by the rotor 27. The spindle 8 rotates with a rotational force from the rotor 27 transmitted through the reducer 7. The spindle 8 transmits a rotational force from the motor 6 to the anvil 10 with balls 48 and the hammer 47 in between. The spindle 8 is at least partially located frontward from the motor 6. The spindle 8 is located frontward from the stator 26. The spindle 8 is at least partially located frontward from the rotor 27. The spindle 8 is at least partially located frontward from the reducer 7. The spindle 8 is at least partially located rearward from the anvil 10.

The spindle 8 includes a spindle shaft 8A, a first flange 8B, a second flange 8C, a connecting portion 8D, and a spindle protrusion 8F.

The spindle shaft 8A is a rod elongated in the front-rear direction. The spindle shaft 8A has the central axis aligned with the rotation axis AX. The first flange 8B extends radially outward from the rear end of the outer circumferential surface of the spindle shaft 8A. The second flange 8C is located rearward from the first flange 8B. The second flange 8C is annular. The connecting portion 8D connects a portion of the first flange 8B to a portion of the second flange 8C. The spindle protrusion 8F protrudes frontward from the front end of the spindle shaft 8A. The first flange 8B supports the front end of the pin 42P. The second flange 8C supports the rear end of the pin 42P. The planetary gears 42 are located between the first flange 8B and the second flange 8C. The planetary gears 42 are rotatably supported by the first flange 8B and the second flange 8C with the pin 42P. The spindle bearing 44 is received in a cylindrical portion 8E of the spindle 8. The cylindrical portion 8E protrudes rearward from the rear surface of the second flange 8C. The spindle bearing 44 holds the cylindrical portion 8E of the spindle 8. The spindle bearing 44 is held by the bearing box 24.

The striker 9 is driven by the motor 6. A rotational force from the motor 6 is transmitted to the striker 9 through the reducer 7 and the spindle 8. The striker 9 strikes the anvil 10 in the rotation direction in response to a rotational force of the spindle 8 rotated by the motor 6. The striker 9 includes the hammer 47, the balls 48, a coil spring 49, and a washer 50. The striker 9 including the hammer 47, the balls 48, the coil spring 49, and the washer 50 is accommodated in the larger cylinder 4A in the hammer case 4.

The hammer 47 is located frontward from the reducer 7. The hammer 47 surrounds the spindle 8. The hammer 47 surrounds the spindle shaft 8A. The hammer 47 is held by the spindle shaft 8A. The balls 48 are located between the spindle 8 and the hammer 47.

The hammer 47 includes a body 47A, an outer cylinder 47B, an inner cylinder 47C, and two hammer projections 47D. The body 47A surrounds the spindle shaft 8A. The body 47A is annular. The outer cylinder 47B and the inner cylinder 47C both protrude rearward from the body 47A. The outer cylinder 47B is located radially outside the inner cylinder 47C. A recess 47E is defined by the rear surface of the body 47A, the inner circumferential surface of the outer cylinder 47B, and the outer circumferential surface of the inner cylinder 47C. The recess 47E is recessed frontward from the rear end of the hammer 47. The recess 47E is annular. The spindle shaft 8A is located radially inward from the body 47A and the inner cylinder 47C. The inner cylinder 47C has an inner circumferential surface 47S facing an outer circumferential surface 8S of the spindle shaft 8A. The outer circumferential surface 8S is in contact with the inner circumferential surface 47S. The outer circumferential surface 8S may be apart from the inner circumferential surface 47S. The hammer projections 47D protrude frontward from the body 47A.

The hammer 47 is rotated by the motor 6. A rotational force from the motor 6 is transmitted to the hammer 47 through the reducer 7 and the spindle 8. The hammer 47 is rotatable together with the spindle 8 in response to a rotational force of the spindle 8 rotated by the motor 6. The rotation axis of the hammer 47 and the rotation axis of the spindle 8 align with the rotation axis AX of the motor 6. The hammer 47 rotates about the rotation axis AX.

The washer 50 is received in the recess 47E. The washer 50 is supported by the hammer 47 with multiple balls 54 in between. The balls 54 are located frontward from the washer 50. The balls 54 are located between the rear surface of the body 47A and the front surface of the washer 50.

The coil spring 49 surrounds the spindle shaft 8A. The coil spring 49 has the rear end supported by the first flange 8B. The coil spring 49 has the front end received in the recess 47E and supported by the washer 50. The coil spring 49 constantly generates an elastic force for moving the hammer 47 forward.

The balls 48 are formed from a metal such as steel. The balls 48 are located between the spindle shaft 8A and the body 47A. The spindle shaft 8A has spindle grooves 8G. The spindle grooves 8G receive at least parts of the balls 48. The spindle grooves 8G are located on the outer circumferential surface of the spindle shaft 8A. The hammer 47 has hammer grooves 47G. The hammer grooves 47G receive at least parts of the balls 48. The hammer grooves 47G are located on the inner circumferential surfaces of the body 47A and the inner cylinder 47C.

Three or more balls 48 are located in the circumferential direction. The spindle shaft 8A has as many (three in the present embodiment) spindle grooves 8G as the balls 48 on its outer circumferential surface. The body 47A and the inner cylinder 47C have as many (three in the present embodiment) hammer grooves 47G as the balls 48 on their inner circumferential surfaces. The three spindle grooves 8G are located circumferentially at equal intervals. The three hammer grooves 47G are located circumferentially at equal intervals.

In the example described below, the three balls 48 are referred to as a first ball 48, a second ball 48, and a third ball 48. The three spindle grooves 8G are referred to as a first spindle groove 8G, a second spindle groove 8G, a third spindle groove 8G. The three hammer grooves 47G are referred to as a first hammer groove 47G, a second hammer groove 47G, and a third hammer groove 47G.

The first ball 48 is located between the first spindle groove 8G and the first hammer groove 47G. The second ball 48 is located between the second spindle groove 8G and the second hammer groove 47G. The third ball 48 is located between the third spindle groove 8G and the third hammer groove 47G. The balls 48 roll along the spindle grooves 8G and the hammer grooves 47G. The hammer 47 is movable together with the balls 48. The spindle 8 and the hammer 47 are movable relative to each other in the axial direction and in the rotation direction within a movable range defined by the spindle grooves 8G and the hammer grooves 47G.

The spindle shaft 8A may have a diameter Da that is two to four times (2×Df≤Da≤2×Df) or 2.5 to 3.5 times (2.5×Df≤Da≤3.5×Df) a diameter Df of the spindle protrusion 8F. The diameter Da of the spindle shaft 8A in the embodiment is about three times the diameter Df of the spindle protrusion 8F.

As shown in FIGS. 8 and 9, each of the three spindle grooves 8G has a central spindle groove portion 800, a first spindle groove portion 801, and a second spindle groove portion 802. The first spindle groove portion 801 is inclined rearward from the central spindle groove portion 800 in a first circumferential direction. The second spindle groove portion 802 is inclined rearward from the central spindle groove portion 800 in a second circumferential direction. As shown in FIG. 7, each of the three hammer grooves 47G has a central hammer groove portion 470, a first hammer groove portion 471, and a second hammer groove portion 472. The first hammer groove portion 471 extends from the central hammer groove portion 470 in the first circumferential direction. The second hammer groove portion 472 extends from the central hammer groove portion 470 in the second circumferential direction.

The anvil 10 is located frontward from the motor 6. The anvil 10 is an output unit of the impact tool 1 that rotates in response to a rotational force from the rotor 27. The anvil 10 is at least partially located frontward from the spindle 8. The anvil 10 is at least partially located frontward from the hammer 47. The anvil 10 is struck by the hammer 47 in the rotation direction.

The anvil 10 includes an anvil shaft 10A and two anvil projections 10B. The anvil shaft 10A is a rod elongated in the front-rear direction. The anvil shaft 10A has the central axis aligned with the rotation axis AX. The anvil projections 10B are located at the rear end of the anvil shaft 10A. The anvil projections 10B protrude radially outward from the rear end of the anvil shaft 10A.

The anvil 10 has a tool hole 10C in its front end face. The anvil 10 has an anvil recess 10D on its rear end face. The tool hole 10C extends rearward from the front end face of the anvil shaft 10A. The tool hole 10C receives a tip tool. The tip tool is attached to the anvil 10. The anvil recess 10D is recessed frontward from the rear end face of the anvil 10. The anvil recess 10D receives the spindle protrusion 8F.

The anvil 10 is rotatably supported by anvil bearings 46. The rotation axis of the anvil 10, the rotation axis of the hammer 47, and the rotation axis of the spindle 8 align with the rotation axis AX of the motor 6. The anvil 10 rotates about the rotation axis AX. The anvil bearings 46 surround the anvil shaft 10A. An O-ring 45 is located between each anvil bearing 46 and the anvil shaft 10A. The anvil bearings 46 are located inside the smaller cylinder 4B in the hammer case 4. The anvil bearings 46 are held by the smaller cylinder 4B in the hammer case 4. The hammer case 4 supports the anvil 10 with the anvil bearings 46. The anvil bearings 46 support a front portion of the anvil shaft 10A in a rotatable manner. In the embodiment, two anvil bearings 46 are arranged in the front-rear direction.

A washer 56 is located frontward from the anvil projections 10B. The washer 56 prevents contact between the front surfaces of the anvil projections 10B and the hammer case 4. A support 57 is located rearward from the anvil bearings 46. The support 57 is in contact with the rear surfaces of the outer rings in the anvil bearings 46. The support 57 is annular. The support 57 reduces the likelihood of the anvil bearings 46 slipping rearward from the smaller cylinder 4B. The support 57 is received in a groove on the inner circumferential surface of the smaller cylinder 4B.

The hammer projections 47D can come in contact with the anvil projections 10B. When the motor 6 operates, with the hammer projections 47D and the anvil projections 10B in contact with each other, the anvil 10 rotates together with the hammer 47 and the spindle 8.

The anvil 10 is struck by the hammer 47 in the rotation direction. When, for example, the anvil 10 receives a higher load in a screwing operation, the anvil 10 may fail to rotate with an urging force from the coil spring 49 alone. This stops the rotation of the anvil 10 and the hammer 47. The spindle 8 and the hammer 47 are movable relative to each other in the axial direction and in the circumferential direction with the balls 48 in between. When the hammer 47 stops rotating, the spindle 8 continues to rotate with power generated by the motor 6. When the hammer 47 stops rotating and the spindle 8 rotates, the balls 48 move backward as being guided along the spindle grooves 8G and the hammer grooves 47G. When the hammer 47 stops rotating and the spindle 8 rotates, the outer circumferential surface 8S of the spindle 8 and the inner circumferential surface 47S of the hammer 47 slide on each other. The hammer 47 receives a force from the balls 48 to move backward with the balls 48. In other words, the hammer 47 moves backward when the anvil 10 stops rotating and the spindle 8 rotates. Thus, the hammer projections 47D are apart from the anvil projections 10B.

The coil spring 49 constantly generates an elastic force for moving the hammer 47 forward. The hammer 47 that has moved backward then moves forward under the elastic force from the coil spring 49. When moving forward, the hammer 47 receives a force in the rotation direction from the balls 48. In other words, the hammer 47 moves forward while rotating. The hammer 47 then comes in contact with the anvil projections 10B while rotating. Thus, the anvil projections 10B are struck by the hammer projections 47D on the hammer 47 in the rotation direction. The anvil 10 receives power from the motor 6 and an inertial force from the hammer 47. The anvil 10 thus rotates about the rotation axis AX at high torque.

The tool holder 11 surrounds a front portion of the anvil 10. The tool holder 11 holds the tip tool received in the tool hole 10C in the anvil 10. The tool holder 11 is attachable to and detachable from the tip tool.

The fan 12 is located rearward from the stator 26 in the motor 6. The fan 12 generates an airflow for cooling the motor 6. The fan 12 is fastened to at least a part of the rotor 27. The fan 12 is fastened to a rear portion of the rotor shaft 33 with a bush 12A. The fan 12 is located between the rear rotor bearing 37 and the stator 26. The fan 12 rotates as the rotor 27 rotates. As the rotor shaft 33 rotates, the fan 12 rotates together with the rotor shaft 33. Thus, air outside the housing 2 flows into the internal space of the housing 2 through the inlets 19 to cool the motor 6. As the fan 12 rotates, the air passing through the internal space of the housing 2 flows out of the housing 2 through the outlets 20.

The battery mount 13 is located in a lower portion of the battery holder 23. The battery mount 13 is connected to the battery pack 25 in a detachable manner. The battery pack is attached to the battery mount 13. The battery pack 25 is placed onto the battery mount 13 from the front of the battery holder 23 and is thus attached to the battery mount 13. The battery pack 25 is pulled forward along the battery mount 13 and is thus detached from the battery mount 13. The battery pack 25 includes a secondary battery. The battery pack 25 in the embodiment includes a rechargeable lithium-ion battery. The battery pack 25 is attached to the battery mount 13 to power the impact tool 1. The motor 6 is driven by power supplied from the battery pack 25.

The trigger lever 14 is located on the grip 22. The trigger lever 14 is operable by the operator to activate the motor 6. The trigger lever 14 is operable to switch the motor 6 between the driving state and the stopped state.

The forward-reverse switch lever 15 is located above the grip 22. The forward-reverse switch lever 15 is operable by the operator. The forward-reverse switch lever is operable to switch the rotation direction of the motor 6 between forward and reverse. This operation switches the rotation direction of the spindle 8.

The interface panel 16 is located on the battery holder 23. The interface panel 16 is located on the upper surface of the battery holder 23 frontward from the grip 22. The interface panel 16 includes one or more operation buttons 16A (multiple operation buttons 16A in the present embodiment). The operation buttons 16A are operable by the operator to change the operation mode of the motor 6.

The hand mode switch button 17 is located above the trigger lever 14. The hand mode switch button 17 is operable by the operator. The hand mode switch button 17 changes the control mode of the motor 6.

The light assemblies 18 emit illumination light. The light assemblies 18 illuminate the anvil 10 and an area around the anvil 10 with illumination light. The light assemblies 18 illuminate an area ahead of the anvil 10 with illumination light. The light assemblies 18 also illuminate the tip tool attached to the anvil 10 and an area around the tip tool with illumination light. The light assemblies 18 in the embodiment are located on the left and the right of the larger cylinder 4A in the hammer case 4.

The spindle 8 includes an internal space 60. The spindle 8 has an opening in its rear end face. The internal space 60 extends frontward from the opening in the rear end face of the spindle 8. The internal space 60 contains a lubricant oil. The lubricant oil includes grease. The rear end of the internal space 60 receives the front end of the pinion gear 41 through the opening in the rear end face of the spindle 8.

The spindle 8 includes first feed ports 81 and a second feed port 82.

The first feed ports 81 are located in the outer circumferential surface of the spindle shaft 8A. The first feed ports 81 allow supply of the lubricant oil from the internal space 60 to between the spindle 8 and the hammer 47. The first feed ports 81 are located rearward from the spindle grooves 8G in the outer circumferential surface of the spindle shaft 8A. The first feed ports 81 allow supply of the lubricant oil to between the outer circumferential surface 8S of the spindle shaft 8A and the inner circumferential surface 47S of the inner cylinder 47C. The first feed ports 81 connect to the internal space 60 through a first flow channel 91 defined inside the spindle shaft 8A. The first flow channel 91 extends radially outward from the internal space 60 to connect the internal space 60 with the first feed ports 81. Under a centrifugal force from the spindle 8, the lubricant oil contained in the internal space 60 flows toward the first feed ports 81 through the first flow channel 91 to between the outer circumferential surface 8S of the spindle shaft 8A and the inner circumferential surface 47S of the inner cylinder 47C.

When the hammer 47 stops rotating and the spindle 8 rotates, the outer circumferential surface 8S of the spindle 8 and the inner circumferential surface 47S of the hammer 47 slide on each other. The lubricant oil is supplied to between the sliding surfaces, or more specifically, to between the outer circumferential surface 8S and the inner circumferential surface 47S, to reduce wear or seizure of the outer circumferential surface 8S and the inner circumferential surface 47S.

Multiple (two in the present embodiment) first feed ports 81 are arranged circumferentially. The two first feed ports 81 are at different positions in the circumferential direction. The two first feed ports 81 are at positions 180 degrees different from each other in the circumferential direction. The two first feed ports 81 are at substantially the same position in the front-rear direction.

The relative angle between one first feed port 81 and the other first feed port 81 in the circumferential direction is a mere example. The first feed ports 81 may be two first feed ports 81, which may be replaced by a single first feed port 81 or by three or more first feed ports 81. The second feed port 82 is located in the front end of the spindle 8. The second feed port 82 allows supply of the lubricant oil from the internal space 60 to between the spindle 8 and the anvil 10. The second feed port 82 connects to the front end of the internal space 60. The second feed port 82 in the embodiment is located in the spindle protrusion 8F. The second feed port 82 allows supply of the lubricant oil to between the surface of the spindle protrusion 8F and the inner surface of the anvil recess 10D. The lubricant oil supplied from the internal space 60 to the second feed port 82 is supplied to between the surface of the spindle protrusion 8F and the inner surface of the anvil recess 10D.

### Operation of Impact Tool

The operation of the impact tool 1 will now be described. To perform, for example, a screwing operation on a workpiece, the tip tool (screwdriver bit) for the screwing operation is placed into the tool hole 10C in the anvil 10. To perform a screwing operation, the forward-reverse switch lever 15 is operated to cause the motor 6 to rotate in the forward direction. The tip tool in the tool hole 10C is held by the tool holder 11. After the tip tool is attached to the anvil 10, the operator grips the grip 22 with, for example, the right hand and pulls the trigger lever 14 with the right index finger. When the trigger lever 14 is pulled, power is supplied from the battery pack 25 to the motor 6 to activate the motor 6 and turn on the light assemblies 18 simultaneously. In response to the activation of the motor 6, the rotor shaft 33 in the rotor 27 rotates. A rotational force of the rotor shaft 33 is then transmitted to the planetary gears 42 through the pinion gear 41. The planetary gears 42 revolve about the pinion gear 41 while rotating and meshing with the internal teeth on the internal gear 43. The planetary gears 42 are rotatably supported by the spindle 8 with the pin 42P. The revolving planetary gears 42 rotate the spindle 8 at a lower rotational speed than the rotor shaft 33.

When the spindle 8 rotates (in the forward direction) with the hammer projections 47D and the anvil projections 10B in contact with each other, the anvil 10 rotates together with the hammer 47 and the spindle 8. Thus, the screwing operation proceeds. When the anvil 10 rotates together with the hammer 47 and the spindle 8, the balls 48 are located between the central spindle groove portion 800 and the central hammer groove portion 470.

When the anvil 10 receives a predetermined or higher load as the screwing operation proceeds, the anvil 10 and the hammer 47 stop rotating. When the hammer 47 stops rotating and the spindle 8 rotates, the balls 48 move backward while rolling between the second spindle groove portion 802 and the second hammer groove portion 472. The hammer 47 receives a force from the balls 48 to move backward with the balls 48. Thus, the hammer projections 47D are apart from the anvil projections 10B. The hammer 47 that has moved backward moves forward while rotating under an elastic force from the coil spring 49. The anvil 10 is struck by the hammer 47 in the rotation direction. The anvil 10 thus rotates about the rotation axis AX at high torque. The screw is thus tightened into the workpiece at high torque.

In an unscrewing operation, the forward-reverse switch lever 15 is operated to cause the motor 6 to rotate in the reverse direction. When the anvil 10 receives a predetermined or higher load as the unscrewing operation proceeds, the anvil 10 and the hammer 47 stop rotating. When the hammer 47 stops rotating and the spindle 8 rotates, the balls 48 move backward while rolling between the first spindle groove portion 801 and the first hammer groove portion 471. The hammer 47 receives a force from the balls 48 to move backward with the balls 48. Thus, the hammer projections 47D are apart from the anvil projections 10B. The hammer 47 that has moved backward moves forward while rotating under an elastic force from the coil spring 49. The anvil 10 is struck by the hammer 47 in the rotation direction. The anvil 10 thus rotates about the rotation axis AX at high torque.

When the hammer 47 stops rotating and the spindle 8 rotates, the outer circumferential surface 8S of the spindle 8 and the inner circumferential surface 47S of the hammer 47 slide on each other. In the embodiment, the three balls 48 are located between the spindle 8 and the hammer 47. This structure reduces the inclination of the hammer 47 with respect to the spindle shaft 8A when the outer circumferential surface 8S of the spindle 8 and the inner circumferential surface 47S of the hammer 47 slide on each other. This reduces the likelihood that a frictional force increases locally between the outer circumferential surface 8S of the spindle 8 and the inner circumferential surface 47S of the hammer 47.

As described above, the impact tool 1 according to the embodiment includes the motor 6, the spindle 8 at least partially located frontward from the motor 6 and rotatable by the motor 6, the hammer 47 surrounding the spindle 8, the anvil 10 at least partially located frontward from the spindle 8 and strikable by the hammer 47 in the rotation direction, and the three or more balls 48 between the spindle 8 and the hammer 47.

The above structure includes the three or more balls 48 between the spindle 8 and the hammer 47 to reduce the inclination of the hammer 47 with respect to the spindle 8. This reduces the likelihood that a frictional force increases locally between the hammer 47 and the spindle 8 when the hammer 47 and the spindle 8 slide on each other, and thus reduces excess wear or seizure of at least the hammer 47 or the spindle 8.

To reduce the inclination of the hammer 47 with respect to the spindle 8, the inner cylinder 47C may be longer in the front-rear direction to increase the contact area between the outer circumferential surface 8S and the inner circumferential surface 47S. However, the inner cylinder 47C longer in the front-rear direction increases the total length of the impact tool 1 and lowers the operability of the impact tool 1. In the embodiment, the three or more balls 48 are located circumferentially between the spindle 8 and the hammer 47 to reduce the inclination of the hammer 47 with respect to the spindle 8 without the length of the inner cylinder 47C being increased in the front-rear direction. The structure according to the present embodiment reduces the inclination of the hammer 47 with respect to the spindle 8 without the total length of the impact tool 1 being increased. The total length of the impact tool 1 refers to the distance (length) in the front-rear direction between the rear end of the rear cover 3 and the front end of the anvil 10.

The spindle 8 in the embodiment has the spindle grooves 8G receiving at least parts of the balls 48. The hammer 47 has the hammer grooves 47G receiving at least parts of the balls 48. The spindle shaft 8A has the spindle grooves 8G corresponding in number to the balls 48 and located circumferentially at equal intervals on its outer circumferential surface. The body 47A and the inner cylinder 47C in the hammer 47 have the hammer grooves 47G corresponding in number to the balls 48 and located circumferentially at equal intervals on their inner circumferential surfaces.

This allows the three or more balls 48 to roll between the spindle grooves 8G and the hammer grooves 47G.

The spindle 8 in the embodiment includes the internal space 60 extending frontward from the opening in its rear end face. The internal space 60 contains a lubricant oil. The spindle 8 includes the first feed ports 81 in its outer circumferential surface to allow supply of the lubricant oil from the internal space 60. The first feed ports 81 are located rearward from the spindle grooves 8G in the outer circumferential surface of the spindle 8.

This structure allows supply of the lubricant oil from the internal space 60 through the first feed ports 81 to between the spindle 8 and the hammer 47, thus reducing wear of the spindle 8 and the hammer 47.

The spindle 8 in the embodiment includes the multiple first feed ports 81 arranged circumferentially.

The first feed ports 81 allow uniform supply of the lubricant oil to between the outer circumferential surface of the spindle 8 and the inner circumferential surface of the hammer 47.

The spindle 8 in the embodiment includes the second feed port 82 in its front end to allow supply of the lubricant oil from the internal space 60 to between the spindle 8 and the anvil 10.

This reduces wear of the spindle 8 and the anvil 10.

### OTHER EMBODIMENTS

In the above embodiment, the three balls 48 are located circumferentially between the spindle shaft 8A and the hammer 47. The balls 48 may be four, five, or six or more balls 48 located circumferentially between the spindle shaft 8A and the hammer 47.

In the above embodiment, the first feed ports 81 are located rearward from the spindle grooves 8G in the outer circumferential surface of the spindle shaft 8A. The first feed ports 81 may be located frontward from the front ends of the spindle grooves 8G. The first feed ports 81 may be located between the rear ends and the front ends of the spindle grooves 8G in the front-rear direction.

In the above embodiment, the impact tool 1 is an impact driver. The impact tool 1 may be an impact wrench.

In the above embodiment, the impact tool 1 may use utility power (alternating current power supply) in place of the battery pack 25.

### REFERENCE SIGNS LIST

1 impact tool
2 housing
2L left housing
2R right housing
2S screw
3 rear cover
3S screw
4 hammer case
4A larger cylinder
4B smaller cylinder
4C joint
6 motor
7 reducer
8 spindle
8A spindle shaft
8B first flange
8C second flange
8D connecting portion
8E cylindrical portion
8F spindle protrusion
8G spindle groove
8S outer circumferential surface
9 striker
10 anvil
10A anvil shaft
10B anvil projection
10C tool hole
10D anvil recess
11 tool holder
12 fan
12A bush
13 battery mount
14 trigger lever
15 forward-reverse switch lever
16 interface panel
16A operation button
17 hand mode switch button
18 light assembly
19 inlet
20 outlet
21 motor compartment
22 grip
23 battery holder
24 bearing box
24A rear annular portion
24B front annular portion
24C joint
25 battery pack
26 stator
27 rotor
28 stator core
29 rear insulator
30 front insulator
30S screw
31 coil
32 rotor core
33 rotor shaft
34A rotor magnet
34B sensor magnet
35 sensor board
36 fusing terminal
37 rear rotor bearing
38 front rotor bearing
41 pinion gear
42 planetary gear
42P pin
43 internal gear
44 spindle bearing
45 O-ring
46 anvil bearing
47 hammer
47A body
47B outer cylinder
47C inner cylinder
47D hammer projection
47E recess
47G hammer groove
47S inner circumferential surface
48 ball
49 coil spring
50 washer
51 hammer case cover
52 bumper
54 ball
56 washer
57 support
60 internal space
81 first feed port
82 second feed port
91 first flow channel
470 central hammer groove portion
471 first hammer groove portion
472 second hammer groove portion
800 central spindle groove portion
801 first spindle groove portion
802 second spindle groove portion
AX rotation axis

What is claimed is:

1. An impact tool, comprising:
a motor;
a spindle at least partially located frontward from the motor and rotatable by the motor;
a hammer surrounding the spindle;
an anvil at least partially located frontward from the spindle and strikable by the hammer in a rotation direction; and
three or more balls between the spindle and the hammer.

2. The impact tool according to claim 1, wherein
the spindle has spindle grooves corresponding in number to the three or more balls, and the spindle grooves are located circumferentially at equal intervals and receive at least parts of the three or more balls, and
the hammer has hammer grooves corresponding in number to the three or more balls, and the hammer grooves are located circumferentially at equal intervals and receive at least parts of the three or more balls.

3. The impact tool according to claim 1, wherein
the spindle includes
an internal space extending frontward from an opening in a rear end face of the spindle and containing a lubricant oil, and
a first feed port in an outer circumference of the spindle to allow supply of the lubricant oil from the internal space.

4. The impact tool according to claim 3, wherein
the first feed port is located rearward from spindle grooves in the outer circumference of the spindle.

5. The impact tool according to claim 3, wherein
the spindle includes a plurality of the first feed ports arranged circumferentially.

6. The impact tool according to claim 3, wherein
the spindle includes a second feed port in a front end of the spindle to allow supply of the lubricant oil from the internal space to between the spindle and the anvil.

7. The impact tool according to claim 2, wherein
the spindle includes
an internal space extending frontward from an opening in a rear end face of the spindle and containing a lubricant oil, and
a first feed port in an outer circumference of the spindle to allow supply of the lubricant oil from the internal space.

8. The impact tool according to claim 4, wherein
the spindle includes a plurality of the first feed ports arranged circumferentially.

9. The impact tool according to claim 4, wherein
the spindle includes a second feed port in a front end of the spindle to allow supply of the lubricant oil from the internal space to between the spindle and the anvil.

10. The impact tool according to claim 5, wherein
the spindle includes a second feed port in a front end of the spindle to allow supply of the lubricant oil from the internal space to between the spindle and the anvil.
